(19) United States
(12) Patent Application Publication
(10) Pub. No.: US 2021/0170733 A1
(43) Pub. Date: Jun. 10, 2021

(54) ANISOTROPIC HEAT-CONDUCTIVE COMPOSITE SILICONE RUBBER SHEET AND METHOD FOR PRODUCING THE SAME

(71) Applicant: SHIN-ETSU CHEMICAL CO., LTD., Tokyo (JP)

(72) Inventors: Yoshinori TAKAMATSU, Annaka-shi (JP); Kazuaki SUMITA, Annaka-shi (JP)

(73) Assignee: SHIN-ETSU CHEMICAL CO., LTD., Tokyo (JP)

(21) Appl. No.: 17/178,653

(22) Filed: Feb. 18, 2021

Related U.S. Application Data
(62) Division of application No. 16/235,375, filed on Dec. 28, 2018.

(30) Foreign Application Priority Data
Jan. 18, 2018 (JP) 2018-006139

(51) Int. Cl. B32B 27/28; B32B 19/04; C08L 83/04; C09D 183/04; C08G 77/20; C08K 7/02; C08G 77/12

(52) U.S. Cl. CPC B32B 27/283; B32B 19/045; C08L 83/04; C09D 183/04; C08K 3/042; C08K 7/02; C08G 77/12; B32B 2307/302; C08G 77/20

(57) ABSTRACT

An anisotropic heat-conductive composite silicone rubber sheet comprising: at least five heat-conductive silicone rubber layers each of which contains a heat-conductive filler and has an Asker C hardness of 2 to 30; and at least five fiber cloth layers each of which is impregnated with a silicone rubber or a silicone resin and in each of which warps comprise highly heat-conductive fibers each having a heat conductivity of 100 W/mK or more, wherein the heat-conductive silicone rubber layers and the fiber cloth layers are arranged alternately; and a method for producing the anisotropic heat-conductive composite silicone rubber sheet.

### CROSS-REFERENCE TO RELATED APPLICATION

This application is a Divisional of copending application Ser. No. 16/235,375, filed on Dec. 28, 2018, which claims priority under 35 U.S.C. § 119(a) on Patent Application No. 2018-006139 filed in Japan on Jan. 18, 2018, all of which are hereby expressly incorporated by reference into the present application.

### TECHNICAL FIELD

The present invention relates to an anisotropic heat-conductive composite silicone rubber sheet which is suitable as a heat-dissipating sheet for a heat-generating electronic component and the like and has excellent heat dissipation properties, and a method for producing the anisotropic heat-conductive composite silicone rubber sheet.

### BACKGROUND ART

LSI chips such as CPUs, driver ICs and memories utilized in electronic devices including personal computers and smart phones generate heat in a larger quantity with the reduction in size and the increase in integration density of the chips. The increase in temperature of the chips caused by the heat induce malfunction of the chips. In order to release the heat more smoothly, the arrangement of the chips in an electronic device has been considered. In addition, it has been also considered to forcibly cool a particular component in a device or the whole of a device, and to apply a sheet for heat dissipation purpose (also referred to as a “heat-dissipating sheet”, hereinafter) to an integrated circuit element to release the heat into a cooling member, a substrate or a housing through the heat-dissipating sheet.

In recent years, however, the increase in integration density in an electronic device typified by a personal computer has been advanced. Therefore, the conventional heat-dissipating sheet has become insufficient for the cooling of these components and elements or the dissipation of heat from these components and elements with the increase in the amount of heat generated in the heat-generating component or integrated circuit element in a device. Particularly in the case where a glass-reinforced epoxy resin or a polyimide resin which has poor heat-dissipating properties is used as the material for a printed circuit board on which the element is to be formed, the heat-dissipating sheet cannot release the heat to the substrate sufficiently. For overcoming this problem, a heat dissipation mode is employed, in which a natural-cooling-type or forcible-cooling-type heat-dissipating device, e.g., a heat-dissipating fin or a heat pipe, is placed in the vicinity of the element to transmit the heat generated in the element to the heat-dissipating device through a heat-dissipating medium.

As a heat-dissipating medium of this mode for the purpose of improving the heat conduction between the element and the heat-dissipating device, a heat-dissipating sheet having high heat conductivity in the vertical direction (orthogonal to the element and the heat-dissipating device) has been proposed, which is produced by dispersing a heat-conductive filler such as boron nitride having anisotropy and carbon fibers in a silicone resin, then curing the resultant dispersion under pressure to cause the heat-conductive filler to align along a direction orthogonal to the direction of the pressurization, and then cutting the resultant product thinly along the direction of the pressurization. For example, a method is known, in which a silicone composition containing scale-like boron nitride is extruded into bar-like articles each having a small cross-sectional area, then several of the shaped bar-like articles are bundled together, then the resultant product is re-molded and cured, and then the cured product is sliced into sheet-like articles (Patent Document 1). In this method, however, voids are formed between the bar-like articles, often resulting in the decrease in heat conductivity. A method is also known, in which a silicone composition containing a fibrous filler is formed into a molded article block by extrusion molding or mold molding, and then the molded article block is sliced into a sheet-like article to produce a sheet (Patent Document 2). In this method, however, the fibrous filler cannot be often cut satisfactorily and accordingly the fibrous filler may be exposed on the sheet surface. The exposure of the fibrous filler cannot be eliminated just by pressing the slice surface of the sheet, and voids are formed as the result of the pressing, resulting in the deterioration in heat conductivity. On the other hand, methods are also proposed, in which graphite sheets having anisotropic heat conductivity are laminated together with a binder material interposed therebetween to form a molded article block, the resultant graphite sheet molded article block is sliced into a sheet-like article to produce a sheet (Patent Documents 3 and 4). In these methods, however, the surface hardness is high and accordingly voids are formed as the results of a thermal history, often resulting in the deterioration in heat conductivity.

### CITATION LIST

Patent Document 1: JP-A 2000-108220
Patent Document 2: JP-A 2014-31501
Patent Document 3: JP-A 2009-295921
Patent Document 4: JP-A 2010-3981

### DISCLOSURE OF INVENTION

The present invention has been made in the above-mentioned situations. The object of the present invention is to achieve high adhesion between a heat-generating body and a heat-dissipating member, and to provide an anisotropic heat-conductive composite silicone rubber sheet that does not undergo the reduction in heat conductivity and a method for producing the anisotropic heat-conductive composite silicone rubber sheet.

The present inventors have made intensive and extensive studies in order to achieve the above-mentioned objects. As a result, it is found that an anisotropic heat-conductive composite silicone rubber sheet that has high adhesiveness and does not undergo the deterioration in heat conductivity can be produced by: bonding a heat-conductive silicone rubber layer to a fiber cloth layer to produce each of heat-conductive composite silicone rubber sheets, wherein the heat-conductive silicone rubber layer contains a heat-conductive filler, has an Asker C hardness of 2 to 30, has a slightly adhesive surface, and has a thickness of 0.01 to 10 mm, and the fiber cloth layer is a fiber cloth layer in which warps comprising highly heat-conductive fibers each having a heat conductivity of 100 W/mK or more are impregnated with a silicone rubber or a silicone resin and which has a thickness of 0.05 to 1.0 mm; laminating the heat-conductive composite silicone rubber sheet or winding the heat-conductive composite silicone rubber sheet around a winding core to produce a molded article block; and slicing the resultant product at an angle orthogonal to the length direction of the warps. This finding leads to the accomplishment of the present invention.

Accordingly, the present invention provides an anisotropic heat-conductive composite silicone rubber sheet and a method for producing the anisotropic heat-conductive composite silicone rubber sheet as mentioned below.

1. An anisotropic heat-conductive composite silicone rubber sheet comprising: at least five heat-conductive silicone rubber layers each of which contains a heat-conductive filler and has an Asker C hardness of 2 to 30; and at least five fiber cloth layers each of which is impregnated with a silicone rubber or a silicone resin and in each of which warps comprise highly heat-conductive fibers each having a heat conductivity of 100 W/mK or more, wherein the heat-conductive silicone rubber layers and the fiber cloth layers are arranged alternately.
2. The anisotropic heat-conductive composite silicone rubber sheet according to the above 1, wherein the thickness of the sheet is 0.1 to 100 mm.
3. The anisotropic heat-conductive composite silicone rubber sheet according to the above 1, wherein the width (P) of each of the heat-conductive silicone rubber layers is 0.01 to 10.0 mm, the width (Q) of each of the fiber cloth layers is 0.05 to 1.0 mm, and the width ratio between both types of the layers, i.e., (P):(Q), is 1:10 to 10:1.
4. The anisotropic heat-conductive composite silicone rubber sheet according to the above 1, wherein each of the heat-conductive silicone rubber layers is a layer made from a cured product of a silicone rubber composition comprising (a) a curable organopolysiloxane, (b) a curing agent and (c) a heat-conductive filler.
5. The anisotropic heat-conductive composite silicone rubber sheet according to the above 1, wherein the silicone rubber with which the fiber cloth layers are impregnated is a cured product of a curable silicone composition comprising (a) a curable organopolysiloxane and (b) a curing agent.
6. The anisotropic heat-conductive composite silicone rubber sheet according to the above 1, wherein the silicone resin with which the fiber cloth layers are impregnated is a thermosoftening silicone resin that is substantially solid under room temperature.
7. The anisotropic heat-conductive composite silicone rubber sheet according to the above 1, wherein each of the silicone rubber layer has a heat conductivity of 0.5 W/mK or more.
8. A method for producing an anisotropic heat-conductive composite silicone rubber sheet, comprising: bonding a heat-conductive silicone rubber layer to a fiber cloth layer to produce each of heat-conductive composite silicone rubber sheets, wherein the heat-conductive silicone rubber layer contains a heat-conductive filler and has an Asker C hardness of 2 to 30, and the fiber cloth layer is produced by impregnating a fiber cloth in which warps comprise highly heat-conductive fibers each having a heat conductivity of 100 W/mK or more with a silicone rubber or a silicone resin; laminating the heat-conductive composite silicone rubber sheets on each other or winding the heat-conductive composite silicone rubber sheets around a winding core to form a molded article block; and slicing the molded article block at an angle orthogonal to length direction of the warps to produce a sheet.
9. The method for producing an anisotropic heat-conductive composite silicone rubber sheet according to the above 8, wherein each of the heat-conductive silicone rubber layers is a silicone rubber layer produced by curing a silicone rubber composition comprising (a) a curable organopolysiloxane, (b) a curing agent and (c) a heat-conductive filler.
10. The method for producing an anisotropic heat-conductive composite silicone rubber sheet according to the above 8, wherein the silicone rubber with which the fiber cloth layers are impregnated is a curable silicone rubber composition comprising (a) a curable organopolysiloxane and (b) a curing agent, and each of the fiber cloth layers is formed by impregnating a fiber cloth in which warps comprise highly heat-conductive fibers each having a heat conductivity of 100 W/mK or more with the curable silicone composition and then curing the impregnated product.
11. The method for producing an anisotropic heat-conductive composite silicone rubber sheet according to the above 8, wherein the silicone resin with which the fiber cloth layers are impregnated is a thermosoftening silicone resin that is substantially solid under room temperature, and each of the fiber cloth layers is formed by impregnating/filling a fiber cloth with the thermosoftening silicone resin.
12. The method for producing an anisotropic heat-conductive composite silicone rubber sheet according to the above 8, wherein each of the heat-conductive silicone rubber layers has a heat conductivity of 0.5 W/mK or more.
13. The method for producing an anisotropic heat-conductive composite silicone rubber sheet according to the above 8, wherein the volume ratio of the heat-conductive silicone rubber layers to the fiber cloth layers in each of which warps comprise highly heat-conductive fibers each having a heat conductivity of 100 W/mK or more is 20:80 to 95:5.
14. The method for producing an anisotropic heat-conductive composite silicone rubber sheet according to above 8, wherein, in each of the fiber cloth layers, the weight ratio of the warps is 90% by weight or more.

### Advantageous Effects of the Invention

The anisotropic heat-conductive composite silicone rubber sheet according to the present invention has a low-hardness and slightly surface-adhesive heat-conductive silicone rubber layer and accordingly can achieve high adhesiveness, and also has reduced thermal resistance and excellent heat conductivity so as to adapt to a terraced structure, e.g., a case where a single heat-dissipating sheet is used for multiple semiconductor chips having different thickness on a substrate. Furthermore, the high heat-conductive fibers in the fiber cloth layer impregnated with a silicone rubber or a silicone resin are arranged in the direction orthogonal to the element and a heat-dissipating device, and therefore the heat conductivity in the vertical direction can become extremely good compared with those of the conventional laminate sheets. Furthermore, the anisotropic heat-conductive composite silicone rubber sheet has little depressions and protrusions on the surface thereof, and therefore the reduction in heat conductivity resulting from the formation of voids can be prevented, leading to the improvement in thermal properties.

### BRIEF DESCRIPTION OF THE DRAWINGS

FIG. 1A is a schematic illustration of a molded article block in which heat-conductive composite silicone rubber sheets are laminated;

FIG. 1B is a schematic illustration of an anisotropic heat-conductive composite silicone rubber sheet produced by slicing the molded article block at an angle orthogonal to the length direction of warps;

FIG. 2A is a schematic illustration of a molded article block in which heat-conductive composite silicone rubber sheets are wound around a winding core; and

FIG. 2B is a schematic illustration of an anisotropic heat-conductive composite silicone rubber sheet produced by slicing the molded article block at an angle orthogonal to the length direction of warps.

### DESCRIPTION OF THE PREFERRED EMBODIMENTS

Hereinbelow, the present invention is described in detail.

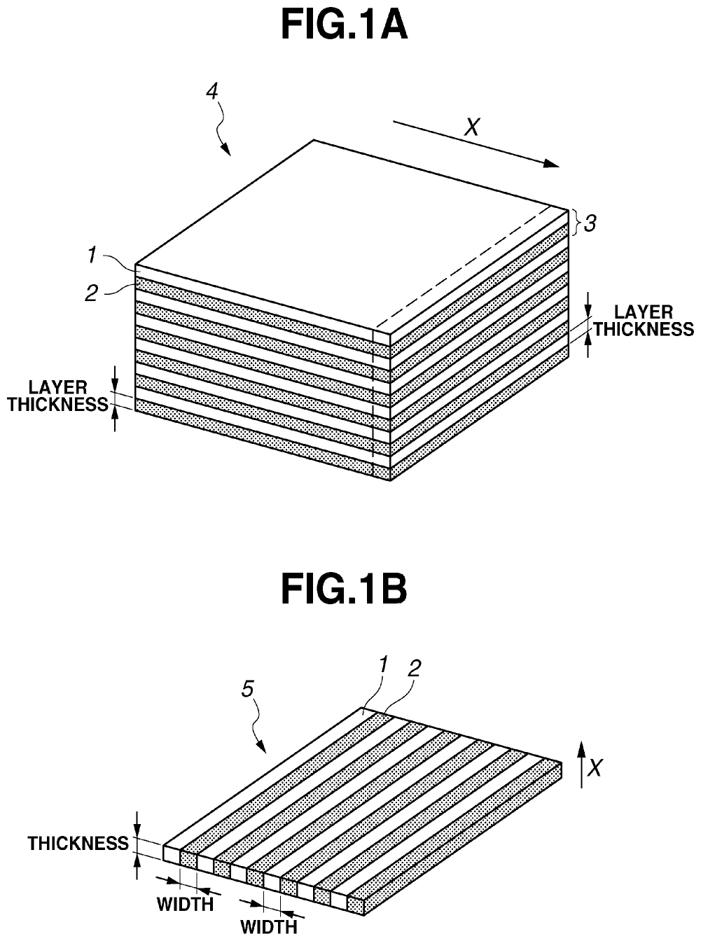

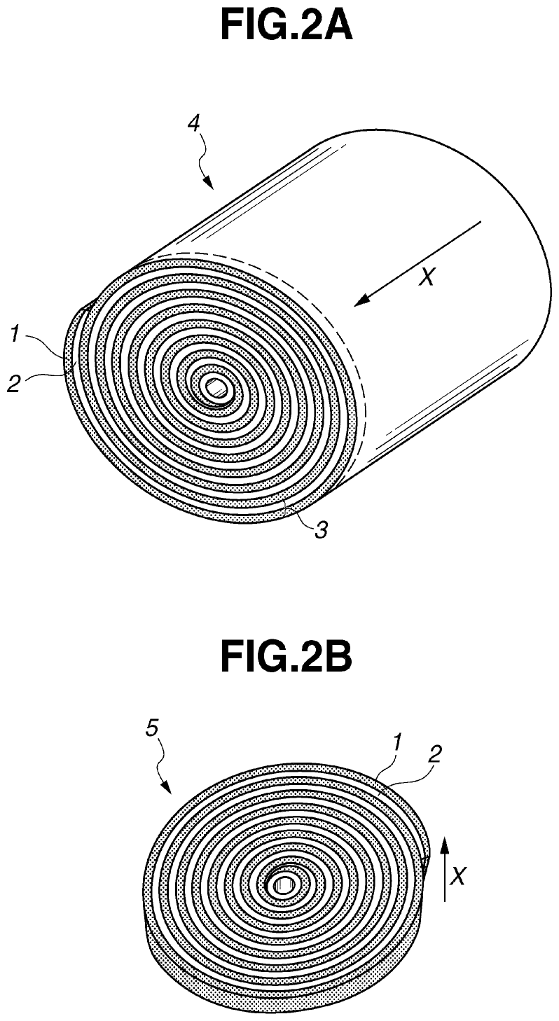

As shown in FIGS. 1A, 1B, 2A and 2B, an anisotropic heat-conductive composite silicone rubber sheet according to the present invention can be produced by: bonding a heat-conductive silicone rubber layer 1 to a fiber cloth layer 2 to produce each of heat-conductive composite silicone rubber sheets 3, wherein the heat-conductive silicone rubber layer 1 contains a heat-conductive filler, has an Asker C hardness of 2 to 30 and has a layer thickness of 0.01 to 10.0 mm, and the fiber cloth layer 2 is impregnated with a silicone rubber or a silicone resin, has a layer thickness of 0.05 to 1.0 mm, and contains warps comprising highly heat-conductive fibers each having a heat conductivity of 100 W/mK or more; laminating the heat-conductive composite silicone rubber sheets 3 on each other or winding the heat-conductive composite silicone rubber sheets 3 around a winding core to form a molded article block 4; and slicing the molded article block 4 at an angle orthogonal to the length direction of the warps to produce a sheet. The anisotropic heat-conductive composite silicone rubber sheet 5 according to the present invention has such a structure that at least five layers of the heat-conductive silicone rubber layers 1 and at least five layers of the fiber cloth layers 2 are arranged alternately.

### Heat-Conductive Silicone Rubber Layer

In the present invention, the heat-conductive silicone rubber layer is preferably produced by curing a silicone rubber composition comprising (a) a curable organopolysiloxane, (b) a curing agent and (c) a heat-conductive filler, has an Asker C hardness of 2 to 30, and has a slightly adhesive surface.

### (a) Organopolysiloxane

The organopolysiloxane that serves as the component (a) can act as a base polymer (main ingredient) of the silicone rubber composition and can be cured to provide a heat-conductive silicone rubber layer. The organopolysiloxane is preferably a diorganopolysiloxane which is basically linear (or contains a branched structure as a part thereof and is therefore branched) and is represented by average compositional formula (1):

R¹ₐSiO_{(4-a)/2} (1)

wherein R¹s independently represent an unsubstituted or substituted monovalent hydrocarbon group having 1 to 12 carbon atoms; and a represents a positive number of 1.8 to 2.2, preferably 1.95 to 2.05.

Examples of R¹ include: an alkyl group such as a methyl group, an ethyl group, a propyl group, an isopropyl group, a butyl group, an isobutyl group, a tert-butyl group, a pentyl group, a neopentyl group, a hexyl group, a heptyl group, an octyl group, a nonyl group, a decyl group and a dodecyl group; a cycloalkyl group such as a cyclopentyl group, a cyclohexyl group and a cycloheptyl group; an aryl group such as a phenyl group, a tolyl group, a xylyl group, a naphthyl group and a biphenylyl group; an aralkyl group such as a benzyl group, a phenylethyl group, a phenylpropyl group and a methylbenzyl group; an alkenyl group such as a vinyl group, an allyl group, a butenyl group, a pentenyl group and a hexenyl group; and a group produced by substituting one, several or all of carbon-bonded hydrogen atoms in each of the aforementioned groups by a halogen atoms such as a fluorine atom, a chlorine atom and a bromine atom, a cyano group or the like, such as a chloromethyl group, a 2-bromoethyl group, a 3-chloropropyl group, a 3,3,3-trifluoropropyl group, a chlorophenyl group, a fluorophenyl group, a cyanoethyl group and a 3,3,4,4,5,5,6,6,6-nonafluorohexyl group. It is preferred that at least two of the R¹s are alkenyl groups. A typical example is a group having 1 to 10 carbon atoms, particularly typically a group having 1 to 6 carbon atoms, and the group is preferably an unsubstituted or substituted alkyl group having 1 to 3 carbon atoms such as a methyl group, an ethyl group, a propyl group, a chloromethyl group, a bromoethyl group, a 3,3,3-trifluoropropyl group and a cyano ethyl group, an unsubstituted or substituted phenyl group such as a phenyl group, a chlorophenyl group and a fluorophenyl group, and an alkenyl group such as a vinyl group and an allyl group.

The kinematic viscosity of the organopolysiloxane (a) at 25° C. is generally 10 to 100,000 mm²/s, particularly preferably 500 to 50,000 mm²/s. If the kinematic viscosity is too small, the storage stability of the resultant composition may be deteriorated. If the kinematic viscosity is too large, the extensibility of the resultant composition may be deteriorated, and the processability of the composition may also be deteriorated. In the present invention, the kinematic viscosity can be measured using an Ostwald's viscometer. In the case of a linear organopolysiloxane, the kinematic viscosity generally corresponds to a number average polymerization degree of about 10 to 1,100, particularly about 50 to 800. In the present invention, the polymerization degree (or molecular weight) can be determined, for example, as a number average polymerization degree (or number average molecular weight) in terms of the equivalent polystyrene molecular weight as measured by a gel permeation chromatography (GPC) analysis using toluene as a developing solvent.

These organopolysiloxanes, which serve as the component (a), may be used singly, or two or more of them which have different kinematic viscosities, molecular structures or the like from each other may be used in combination.

In the case where the curing agent which serves as the component (b) is an addition-curable curing agent comprising a combination of an organohydrogenpolysiloxane and a platinum-based catalyst (a hydrosilylated reaction curing agent), the organopolysiloxane which serves as the component (a) is an organopolysiloxane having 2 or more, preferably 3 to 100, more preferably about 3 to 50 alkenyl groups each bonded to a silicon atom per molecule. If the content of the alkenyl groups each bonded to a silicon atom is smaller than the above-mentioned lower limit, the resultant composition may not be cured sufficiently. As the alkenyl group bonded to a silicon atom, a vinyl group is preferred. The alkenyl group may be located one or both of a molecule chain terminal and a side chain, and it is preferred that at least one alkenyl group is bonded to a silicon atom located at a molecule chain terminal.

In the case where the curing agent which serves as the below-mentioned component (b) is an organic peroxide, the organopolysiloxane which serves as the component (a) may contain the alkenyl group or may not contain the alkenyl group in the molecule. It is preferred, but not limited to, two or more, to, preferably 3 to 100, more preferably about 3 to 50 alkenyl groups each bonded to a silicon atom are contained per molecule in the organopolysiloxane.

### (b) Curing Agent

The curing agent (b) is a component which serves as a cross-linking agent (curing agent) for the component (a). In the present invention, a hydrosilylated reaction curing agent (i.e., a combination of an organohydrogenpolysiloxane and a platinum-based catalyst) or an organic peroxide can be used. Hereinbelow, these components are described in detail.

In the case where the curing agent which serves as the component (b) is a hydrosilylated reaction curing agent (i.e., a combination of an organohydrogenpolysiloxane and a platinum-based catalyst), an organohydrogenpolysiloxane having, per molecule, 2 or more, preferably 2 to 200, more preferably about 3 to 100 hydrogen atoms each bonded to a silicon atom (i.e., SiH groups) can be used as the organohydrogenpolysiloxane in the curing agent.

As an example of the organic group bonded to a silicon atom in the organohydrogenpolysiloxane, an unsubstituted or substituted monovalent hydrocarbon group free of an aliphatic unsaturated bond can be mentioned. Specific examples of the organic group include the same unsubstituted or substituted monovalent hydrocarbon groups which are exemplified as the unsubstituted or substituted monovalent hydrocarbon group bonded to a silicon atom which is other than an aliphatic unsaturated group such an alkenyl group as described in the explanation of the component (a). Among these organic groups, a methyl group is preferred from the viewpoint of easiness of synthesis and economic performance.

The structure of the organohydrogenpolysiloxane in the hydrosilylated reaction curing agent which serves as the component (b) in the present invention is not particularly limited, and may be any structure selected from a linear structure, a branched structure, a cyclic structure and three-dimensional net-like structure, and is preferably a linear structure.

It is preferred that the organohydrogenpolysiloxane generally has a polymerization degree (or the number of silicon atoms) of 2 to 200, particularly 2 to 100, especially about 2 to 50.

Preferred specific examples of the organohydrogenpolysiloxane include 1,1,3,3-tetramethyldisiloxane, 1,3,5,7-tetramethylcyclotetrasiloxane, tris(hydrogendimethylsiloxy)methylsilane, tris(hydrogendimethylsiloxy)phenylsilane, methylhydrogencyclopolysiloxane, a methylhydrogensiloxane-dimethylsiloxane cyclic copolymer, methylhydrogenpolysiloxane capped with a trimethylsiloxy group at each molecular chain terminal, a dimethylsiloxane-methylhydrogensiloxane copolymer capped with a trimethylsiloxy group at each molecule chain terminal, a dimethylsiloxane-methylhydrogensiloxane-methylphenylsiloxane copolymer capped with a trimethylsiloxy group at each molecule chain terminal, dimethylpolysiloxane capped with a dimethylhydrogensiloxy group at each molecule chain terminal, a dimethylsiloxane-methylhydrogensiloxane copolymer capped with a dimethylhydrogensiloxy group at each molecule chain terminal, a dimethylsiloxane-methylphenylsiloxane copolymer capped with a dimethylhydrogensiloxy group at each molecule chain terminal, methylphenylpolysiloxane capped with a dimethylhydrogensiloxy group at each molecule chain terminal, a copolymer composed of a (CH₃)₂HSiO_{1/2} unit, a (CH₃)₃SiO_{1/2} unit and a SiO_{4/2} unit, a copolymer composed of a (CH₃)₂HSiO_{1/2} unit and a SiO_{4/2} unit, and a copolymer composed of a (CH₃)₂HSiO_{1/2} unit, a SiO_{4/2} unit and a (C₆H₅)₃SiO_{1/2} unit.

In the component (b), these organohydrogenpolysiloxanes may be used singly, or two or more of them may be used in combination.

The amount of the organohydrogenpolysiloxane to be contained in the hydrosilylated reaction curing agent is preferably such an amount that the amount of SiH groups in the organohydrogenpolysiloxane can become 0.5 to 5.0 moles, more preferably 0.8 to 4.0 moles, per 1 mole of the alkenyl groups in the component (a). When the amount of the SiH groups in the organohydrogenpolysiloxane is 0.5 mole or more per 1 mole of the alkenyl groups in the component (a), the composition can be cured sufficiently, and accordingly a cured product can have sufficient strength and the handling of a molded article complex can become easy. When the amount of the SiH groups in the organohydrogenpolysiloxane is 5.0 moles or less, the formation of a complex with the below-mentioned fiber cloth layer can be facilitated.

The platinum-based catalyst to be used in combination with the organohydrogenpolysiloxane as the hydrosilylated reaction curing agent is a catalyst component that is added for the conversion of the composition of the present invention to a crosslinked cured article (silicone rubber cured article) having a three-dimensional net-like structure for the purpose of accelerate a hydroxylation addition reaction of an alkenyl group in the component (a) with a hydrogen atom bonded to a silicon atom in the organohydrogenpolysiloxane.

The platinum-based catalyst component to be used may be selected appropriately among from known catalysts that have been used in hydrosilylation addition reactions conventionally. Specific examples of the platinum-based catalyst component include platinum-group metal catalysts, such as: a platinum-group metal element such as platinum (including platinum black), rhodium and palladium; platinum chloride, chloroplatinic acid and a chloroplatinic acid salt, such as H₂PtlC₄.xH₂O, H₂PtCl₆.xH₂O, NaHPtCl₆.xH₂O, KHPtCl₆.xH₂O, Na₂PtCl₆.xH₂O, K₂PtCl₄.xH₂O, PtCl₄.xH₂O, PtCl₂, Na₂HPtCl₄.xH₂O (wherein x represents an integer of 0 to 6, preferably 0 or 6); an alcohol-modified chloroplatinic acid; a complex of chloroplatinic acid and an olefin; a product produced by supporting a platinum-group metal such as platinum black and palladium on a carrier such as alumina, silica, carbon and the like; a rhodium-olefin complex; chlorotris(triphenylphosphine)rhodium (Wilkinson's catalyst); and a platinum-group metal or a platinum-group metal compound, e.g., a complex of platinum chloride, chloroplatinic acid or a chloroplatinic acid salt with a vinyl-group-containing siloxane. These platinum-group metal catalysts may be used singly, or two or more of them may be used in combination.

The amount of the platinum-based compound which serves as the platinum-based catalyst component may be an effective amount needed for the curing of the composition, and is generally 0.1 to 1,000 ppm, preferably 0.5 to 500 ppm, in terms of the weight of the platinum-group metal element per the weight of the component (a).

In the case where the curing agent which serves as the component (b) is an organic peroxide, the curing reaction of the silicone rubber composition with the organic peroxide occurs preferably by carrying out the radical polymerization of a linear organopolysiloxane having an alkenyl group (e.g., a vinyl group) at one or both of a molecule chain terminal (one terminal or both terminals) and a molecule chain non-terminal (in the middle of the molecule chain) in the presence of an organic peroxide-type compound. Examples of the organic peroxide-type compound include a diacyl peroxide and a dialkyl peroxide. In many cases, the organic peroxide-type compound is used in a form diluted in an organic solvent or a form dispersed in a silicone component, because organic peroxide-type compounds are sensitive to light and heat and are therefore unstable and solid organic peroxide-type compounds cannot be dispersed in the composition easily.

The amount of the organic peroxide-type compound to be added may be a so-called catalytic amount, and is generally preferably about 0.1 to 2 parts by weight per 100 parts by weight of the organopolysiloxane which serves as the component (a), preferably an organopolysiloxane containing an alkenyl group.

### (c) Heat-Conductive Filler

As the heat-conductive filler (c), known materials which have been generally used as heat-conductive fillers for use applications of this type with no limitation. For example, a metal such as copper, silver and aluminum; a metal oxide such as aluminum oxide, silica, magnesium oxide, aluminum hydroxide and zinc oxide; a ceramic such as aluminum nitride, silicon nitride, silicon carbide and boron nitride; and artificial diamond can be used. Among these materials, aluminum oxide and aluminum nitride are preferred because these materials are easily available and are relatively inexpensive.

The amount of the component (c) is generally preferably 100 to 1,800 parts by weight, particularly preferably 200 to 1,600 parts by weight, per 100 parts by weight of the component (a). When the amount is equal to or more than the above-mentioned lower limit, sufficient heat conductivity can be achieved. When the amount is equal to or less than the above-mentioned upper limit, the homogeneous blending of the component (c) in the composition can be achieved easily and the moldability of the composition can become good. The average particle diameter of the component (c) is preferably 0.5 to 100 μm, particularly preferably 1 to 50 μm, especially preferably 1 to 10 μm. When the average particle diameter is equal to or less than the above-mentioned upper limit, the area of contact with the silicone resin can be secured satisfactorily, and therefore good pumping out resistance can be achieved. When the average particle diameter is equal to or lower than the above-mentioned lower limit, the mixing with the silicone resin can be achieved easily. The average particle diameter can be determined, for example, as a cumulative mass average diameter (or a median diameter, D₅₀) in a grain size distribution measurement by a laser beam diffraction method.

The slightly surface-adhesive heat-conductive silicone rubber layer in the heat-conductive composite silicone rubber sheet according to the present invention can be produced by heat-curing a silicone rubber composition, which is prepared by homogeneously mixing the components (a) to (c) and optionally other arbitrary components (e.g., various additives), under the curing conditions generally employed for an addition-curable or organic peroxide-curable silicone rubber composition. The hardness of the heat-conductive silicone rubber layer is an Asker C hardness of 2 to 30, more preferably 6 to 20, as measured in accordance with JIS K 7312:1996. If the hardness is less than 2, the adhesiveness is strong (slight surface-adhesiveness is poor) and therefore strength is poor, and the rubber layer may be broken during handling, and accordingly handling properties may be deteriorated. If the hardness is more than 30, the adhesiveness of the surface is deteriorated (slight surface-adhesiveness is poor) and the adhesiveness of the anisotropic heat-conductive composite silicone rubber sheet may also be deteriorated.

The term “slight surface-adhesiveness” as used herein means that adhesion can be achieved by applying a small amount of pressure at ambient temperature within a short period of time.

The heat conductivity of the heat-conductive silicone rubber layer is generally 0.2 W/mK or more, and is preferably 0.5 W/mK or more from the viewpoint of thermal resistance. The upper limit of the heat conductivity is not particularly limited, and is generally 30 W/mK or less.

In this case, the layer thickness of the heat-conductive silicone rubber layer is preferably 0.01 to 20 mm, more preferably 0.02 to 1.0 mm, still more preferably 0.02 to 10 mm. If the layer thickness is less than 0.01 mm, strength may be deteriorated. If the layer thickness is more than 20 mm, sufficient heat conductivity may not be achieved.

### Fiber Cloth Layer

In the present invention, the fiber cloth layer is one produced by impregnating a fiber cloth layer in which warps comprise highly heat-conductive fibers each having a heat conductivity of 100 W/mK or more with a silicone rubber or a silicone resin.

The thickness of the fiber cloth layer in which warps comprise highly heat-conductive fibers each having a heat conductivity of 100 W/mK or more is preferably 0.03 to 1.0 mm, more preferably 0.05 to 0.9 mm. If the thickness is less than 0.03 mm, the strength of the fiber cloth may be insufficient and the production of the fiber cloth may become difficult. If the thickness is more than 1.0 mm, the adhesiveness of the heat-conductive silicone rubber layer may be deteriorated.

### (d) Fiber Cloth

The fiber cloth to be used in the present invention is a cloth in which heat-conductive fibers each having a heat conductivity of 100 W/mK or more are used as some or all of warps. The term “warp” as used herein refers to a fiber that is orthogonal to a cutting face of a finished fiber cloth-containing heat-conductive resin cured article. The X direction shown in FIG. 1A is the fiber direction (length direction) of the warp.

Specific examples of the heat-conductive fiber include a graphitized carbon fiber, a silicon carbide fiber, a boron nitride nanotube fiber, a silver fiber, an aluminum fiber and a copper fiber. From the viewpoint of heat conductivity, it is preferred to use a heat-conductive fiber preferably having a heat conductivity of 200 W/mK or more, more preferably 400 W/mK or more, as measured in the direction of the length of the fiber (also referred to as a “fiber direction”; i.e., the X direction shown in FIG. 1A). Among these fibers, a graphitized carbon fiber is preferably used because of the high heat conductivity and easy availability thereof.

The weft to be used in the fiber cloth is not particularly limited, and an inorganic fiber, an organic fiber and the like can be used. Among these fibers, a glass fiber, an alumina fiber, a cellulose fiber, a polyester fiber, a polyethylene fiber and the like can be used preferably from the viewpoint of strength, and a polyester fiber can be used more preferably from the viewpoint of flexibility.

The type of the weaving of the fiber cloth is not particularly limited, and plain weave (including a type in which the number of warps is different from the number of wefts), sateen weave, twill weave and the like are mentioned. Among these types, plain weaving in which the number of warps and the number of wefts are different from each other is preferably employed, from the viewpoint of heat conductivity.

The proportion between the number of warps and the number of wefts in the fiber cloth can be adjusted arbitrarily. From the viewpoint of heat conductivity, the percentage of warps is preferably 40% by weight or more, more preferably 90% by weight or more, in the whole of the fiber cloth. If the percentage of the warps in the heat-conductive fiber is less than 40% by weight, heat conductivity may be deteriorated. The upper limit of the percentage of the warps is preferably 99.99% by weight or less in the whole of the fiber cloth.

The weight of the fiber cloth per 1 m² is not particularly limited, and is preferably about 10 to 500 g/m², more preferably 50 to 250 g/m². If the amount of the fiber cloth per 1 m² is smaller than 10 g/m², the fiber density may be decreased and accordingly a sufficient heat conductivity may not be achieved. If the amount of the fiber cloth per 1 m² is larger than 500 g/m², the impregnation with a resin may not be carried out easily. A single piece of the fiber cloth may be used, or two or more pieces of fiber cloths may be used in a stacked form.

As mentioned above, the fiber cloth to be used in the present invention is most preferably a hybrid fiber cloth in which carbon fibers each having a heat conductivity of 400 W/mK or more as measured in the length direction (fiber direction, FIG. 1A) are used as warps and polyester fibers are used as wefts, and also preferably contains carbon fibers in an amount of 90 to 99.99% by weight inclusive.

The thickness of the fiber cloth layer (single layer) is preferably 30 to 500 μm, more preferably 50 to 300 μm.

In the case where the thickness of the fiber cloth (single layer) is equal to or lower than half the entire thickness of the desired fiber cloth layer, a fiber cloth layer having a desired thickness can be produced by impregnating or impregnating and curing multiple pieces of the fiber cloths with a silicone resin while stacking the fiber cloths. When multiple pieces of the fiber cloths each having a thickness falling within the above-mentioned thickness range are impregnated with the silicone resin or impregnated with the silicon resin and cured while stacking the fiber cloths, a fiber cloth layer having a thickness of more than 500 μm can be produced. In this case, the thickness of the laminate fiber cloth is up to 50 mm, particularly up to 20 mm.

### (e) Silicone Rubber or Resin

In the present invention, as the silicone rubber or resin (e) with which the fiber cloths (d) are to be impregnated, any one of (e-1) curable silicone rubber compositions and (e-2) thermosoftening silicone resins mentioned below can be used.

(e-1) Curable Silicone Rubber Composition

As the curable silicone rubber composition (e-1), a curable silicone rubber composition composed of a composition containing the same components as the organopolysiloxane (a) and the curing agent (b) can be used preferably. A slightly surface-adhesive fiber cloth layer impregnated/filled with a silicone rubber can be formed by impregnating and filling the fiber cloth (d) with the component (e-1) and then curing the resultant product.

The component (e-1) may optionally contain a surface-treating agent as an arbitrary component for the purpose of improving the wettability to the fiber cloths (d) or the adhesion to the heat-conductive silicone rubber layers. Specific examples of the surface-treating agent include: an organoxysilane compound such as an alkoxysilane; and a hydrolysable group-containing organic silicon compound such as a linear diorganopolysiloxane in which one molecule chain terminal is capped with a triorganoxysilyl group such as a trialkoxysilyl group.

(e-2) Thermosoftening Silicone Resin

As the thermosoftening silicone resin (e-2), a silicone resin that is substantially solid (i.e., non-liquid having no self-fluidability) under room temperature (25° C.±5° C.) can be used. In the present invention, the thermosoftening silicone resins mentioned below and the like can be mentioned, for example.

The component (e-2) may be one which is substantially solid (i.e., non-liquid without self-fluidability) at room temperature (25° C.±5° C.) and can be thermally softened, reduced in viscosity or melted and consequently can be fluidized at least on a part contacting with a heat-generating component generally at a temperature equal to 40° C. or higher and a highest temperature generated as the result of the heat generation by the heat-generating component, i.e., 40 to 120° C., particularly about 40 to 90° C.

In the present invention, it is particularly preferred that the softening point (or melting point) of the component (e-2) is 40 to 120° C., more preferably 45 to 100° C. If the softening point is lower than 40° C., when the temperature of the atmosphere is high, the molded article may be fluidized excessively and therefore the handling of the molded article may become difficult. If the softening point is higher than 120° C., the thermal softening temperature is too high and therefore molding may become difficult to perform. The softening point can be determined by a falling ball measurement method (i.e., a measurement in which a temperature at which a falling ball sinks completely into a resin when the resin is heated in a falling ball viscometer is defined as a softening point) or the like.

The component (e-2) is not particularly limited, as long as the above-mentioned requirements can be met. With respect to the thermosoftening property as mentioned above, the composition of the silicone resin is a critical factor.

Particularly with respect to the component (e-2), it is required to be substantially solid at room temperature, from the viewpoint that the deformation of the heat-conductive silicone rubber layer can be prevented and good workability can be achieved when the fiber cloth layer produced by combining the component (e-2) with the fiber cloth (d) (i.e., a structure in which the fiber cloth is impregnated/filled with the thermosoftening silicone resin) is laminated on the heat-conductive silicone rubber layer. An example of the component (e-2) which meets these requirements is: a silicone resin which is a copolymer having a three-dimensional net-like structure containing a trifunctional silsesquioxane structural unit represented by the formula: R²SiO_{3/2} (also referred to as “T unit”, hereinafter) and/or a tetrafunctional structural unit represented by the formula: SiO₂ (also referred to as “Q unit”, hereinafter), which is a branched structural unit, as the main components (e.g., in an amount of 40 mol % or more, particularly 50 mol % or more); preferably a silicone resin having a three-dimensional net-like structure, which is a copolymer of the T unit and/or the Q unit and a bifunctional siloxane structural unit represented by the formula: R²₂SiO (also referred to as “D unit”, hereinafter); more preferably a copolymer having a three-dimensional net-like structure containing the T unit and/or the Q unit and the D unit, wherein a terminal is capped with a monofunctional siloxy structural unit represented by the formula: R²₃SiO_{1/2} (also referred to as “M unit”, hereinafter) (i.e., a copolymer containing the T unit and/or the Q unit and further containing the M unit and the D unit).

The R²s preferably independently represent a hydrogen atom, or a monovalent hydrocarbon group which has 1 to 8 carbon atoms and may contain the same of different carbonyl group other than an aryl group. Specific examples of R² include a hydrogen atom; an alkyl group such as a methyl group, an ethyl group, a propyl group, a butyl group, a pentyl group and a hexyl group; a cycloalkyl group such as a cyclopentyl group and a cyclohexyl group; an alkenyl group such as a vinyl group, an allyl group, a propenyl group, an isopropenyl group and a butenyl group; and an acyl group such as an acryloyl group and a methacryloyl group. From the viewpoint that a raw material is easily available, a hydrogen atom, a methyl group, an ethyl group, a vinyl group or the like can be used preferably as R².

As the component (e-2), one or two silicone resin copolymers each containing the above-mentioned branched structural unit and generally having a three-dimensional net-like structure can be used. It also possible to use a mixture of the component (e-2) and a three-dimensional net-like copolymer having the above-mentioned branched structural units, which can be prepared by adding a substantially linear (or branched linear and optionally containing the T unit or the Q unit in a small amount) organopolysiloxane (e.g., a silicone oil or a silicone crude rubber), which contains the D unit as the main component (generally in an amount of 80 mol % or more, preferably 90 mol % or more) and therefore in which the main chain is composed substantially of a D unit-repeating structure and a terminal of the molecule chain is capped with the M unit (or is not capped), in an amount of 1 to 100 parts by weight, particularly 2 to 50 parts by weight, to 100 parts by weight of the three-dimensional net-like copolymer.

Among these components, as the component (e-2), a silicone resin composition is preferred, which is a combination of a silicone resin containing the T unit and the D unit (optionally also containing the M unit), a silicone resin containing the T unit and a silicone oil or silicone raw rubber having a viscosity of 100 Pa·s or more at 25° C. as measured with a rotary viscometer. The silicone resin may be one in which a terminal is capped with R²₃SiO_{1/2} (the M unit).

Hereinbelow, the composition of the component (e-2) is described more specifically. The thermosoftening silicone resin generally has a three-dimensional net-like structure containing, as the main components, the T unit and/or the Q unit, and is designed so as to contain only the M unit and the T unit or only the M unit and the Q unit. However, in order to increase the toughness during solidification (e.g., improve the brittleness of the fiber cloth layer which is prepared by impregnating/filling voids in the fiber cloth with the thermosoftening silicone resin, and prevent the fiber cloth layer from breakage during handling), it is particularly effective to introduce the T unit, and it is preferred to use the D unit in combination. The substituent (R²) in the T unit is desirably a methyl group or a phenyl group, and the substituent (R²) in the D unit is desirably a methyl group, a phenyl group or a vinyl group. The content ratio (by mole) of the T unit and/or the Q unit to the D unit is preferably 10:90 to 90:10, particularly preferably 20:80 to 80:20.

A conventional silicone resin that is synthesized only from the M unit and the T unit or the M unit and the Q unit can become usable by mixing the silicone resin with a high-viscosity silicone oil (e.g., having a viscosity of 1,000 Pa·s or more as measured at 25° C. with a rotary viscometer) or raw rubbery silicone compound having a structure containing the T unit and mainly composed of a D unit repeating structure (having the M unit at a terminal). In this case, it becomes possible to improve the brittleness of the heat-conductive composite silicone rubber sheet prepared by laminating the fiber cloth layer and the heat-conductive silicone rubber layer, to improve the adhesion of the heat-conductive silicone rubber layer upon the application of a heat shock, and to prevent the delamination between the fiber cloth layer and the heat-conductive silicone rubber layer. Therefore, in the case where a silicone resin having a three-dimensional net-like structure containing the T unit and not containing the D unit is used, it is preferred to add a high-viscosity silicone oil or silicone raw rubber compound containing the D unit as the main component to the silicone resin.

For these reasons, in the case where the silicone resin having a softening point or melting point of higher than room temperature contains the T unit but does not contain the D unit, this material can be converted to a material having excellent handling properties by adding a high-viscosity silicone oil or silicone raw rubber which contains the D unit as the main component. In this case, the addition amount of the high-viscosity silicone oil or raw rubber-like silicone compound containing the D unit as the main component or the like is preferably 1 to 100 parts by weight, particularly preferably 2 to 10 parts by weight, per 100 parts by weight of the silicone resin having a softening point or melting point of higher than room temperature. When the addition amount is 1 part by weight or more, the adhesion of the heat-conductive silicone rubber layer can be improved sufficiently, and the possibility of the occurrence of delamination can be reduced. When the addition amount is 100 parts by weight or less, the thermal resistance can be reduced and the heat conductivity can be improved.

The component (e-2) can cause critical (largely temperature-dependent) viscosity reduction, and therefore it is desirable that the component (e-2) to be used has a relatively low molecular weight. The molecular weight of the thermosoftening silicone resin (e-2) is desirably 500 to 10,000, particularly desirably 1,000 to 6,000. In general, the molecular weight can be determined as, for example, a number average molecular weight in terms of the equivalent polystyrene molecular weight as measured by a gel permeation chromatography analysis using toluene or the like as a developing solvent.

The component (e-2) is preferably one which can impart adhesiveness and stickiness to the anisotropic heat-conductive composite silicone rubber sheet according to the present invention. As the component (e-2), a polymer having a single viscosity or the like may be used or, alternatively, two or more types of components having different viscosities from each other may also be used from the viewpoint of providing a sheet having a superior balance between strength and stickiness.

A specific example of the component (e-2) is a silicone resin which is represented by the formula shown below and contains a bifunctional siloxane structural unit (D unit) and a trifunctional silsesquioxane structural unit (T unit) at a specified content ratio:

D¹ₘTₚD²ₙ

wherein D¹ represents a dimethylsiloxane unit (i.e., (CH₃)₂SiO); T represents a phenylsilsesquioxane unit (i.e., (C₆H₅)SiO_{3/2}); and D² represents a methylvinylsiloxane unit (i.e., (CH₃)(CH₂═CH)SiO), provided that the (m+n)/p ratio (by mole)=0.25 to 4.0 or the (m+n)/m ratio (by mole)=1.0 to 4.0.

Another specific example is a silicone resin which is represented by the formula shown below and contains a monofunctional siloxy structural unit (M unit), a bifunctional siloxane structural unit (D unit) and a trifunctional silsesquioxane structural unit (T unit) at a specified content ratio:

MₗD¹ₘTₚD²ₙ

wherein M represents a trimethylsiloxane unit (i.e., (CH₃)₃SiO_{1/2}); and D¹, T and D² are as defined above, provided that the (m+n)/p ratio (by mole)=0.25 to 4.0, or the (m+n)/m ratio (by mole)=1.0 to 4.0, or the 1/(m+n) ratio (by mole)=0.001 to 0.1.

Still another specific example is a silicon resin which is represented by the formula shown below and contains a monofunctional siloxy structural unit (M unit), a bifunctional siloxane structural unit (D unit) and a tetrafunctional structural unit (Q unit) at a specified content ratio:

MₗD¹ₘQ_{q}D²ₙ

wherein Q represents SiO_{4/2}; and M, D¹ and D² are as defined above, provided that the (m+n)/q ratio (by mole)=0.25 to 4.0, or the (m+n)/m ratio (by mole)=1.0 to 4.0, or the 1/(m+n) ratio (by mole)=0.001 to 0.1.

These silicone resins may be used singly, or two or more of them may be used in combination.

It is also preferred that the fiber cloth layer impregnated with the silicone rubber or the silicone resin also has slight surface adhesiveness. When the fiber cloth layer also has slight surface adhesiveness, the contact area with the heat-conductive silicone rubber layer can be increased significantly, good adhesion between the fiber cloth layer and the heat-conductive silicone rubber layer can be achieved reliably in the anisotropic heat-conductive composite silicone rubber sheet, and consequently the reduction in heat conductivity resulting from the formation of voids rarely occurs, resulting in the improvement in thermal properties. In this case, the slight surface adhesiveness can be achieved by forming a silicone rubber particularly having an Asker C hardness of 2 to 10 using the curable silicone rubber composition (e-1), or by using the heat-curable silicone resin.

### Production of Heat-Conductive Composite Silicone Rubber Sheet

The method for producing the heat-conductive composite silicone rubber sheet is not particularly limited, and a press method, a coating method or the like is effective, and a coating method is generally effective.

### Preparation of Composition for Heat-Conductive Silicone Rubber Layer

The composition for the heat-conductive silicone rubber layer can be prepared by homogeneously mixing the above-mentioned components (i.e., the components (a) to (c) and optionally other components) at room temperature (25° C.±5° C.) for 0.5 to 5 hours, particularly about 1 to 3 hours, using a mixer such as a planetary mixer. In this step, an addition reaction regulator, an internal mold release agent for promoting the releasing from a separator, a silicone wetter, a coloring agent, a reinforcing agent such as reinforcing silica, a flame retardant agent and the like may be added as required, as long as the heat conductive performance or the like cannot be deteriorated.

The silicone composition thus prepared is preferably has a liquid form having self-fluidability at room temperature, because the silicone composition is subjected to molding. More specifically, it is preferred that the silicone composition has a viscosity of 500,000 mPa·s or less (generally 50 to 500,000 mPa·s), particularly preferably 100 to 50,000 mPa·s, still more preferably about 300 to 10,000 mPa·s, at 25° C. as measured using a rotary viscometer (e.g., BL model, BH model, BS model, corn plate type, a rheometer).

The conditions for the curing of the curable silicone composition for forming the heat-conductive silicone rubber layer to be used in the present invention are not particularly limited. The curing is preferably carried out at a temperature of 80 to 150° C., more preferably 100 to 130° C., preferably for 1 minute to 1 hour, more preferably about 5 minutes to 30 minutes.

### Production of Fiber Cloth Layer

<Case where Curable Silicone Rubber Composition is Used>

Hereinbelow, the method for producing a fiber cloth layer in which a fiber cloth is impregnated or filled with the curable silicone rubber (e-1) is described.

Firstly, a fiber cloth is supplied (arranged) on a mold-release-treated polymer film (base material), a predetermined amount of a liquid curable silicone rubber composition (e-1) is applied onto the surface of the fiber cloth to impregnate the fiber cloth with the liquid curable silicone rubber composition (e-1). Subsequently, the impregnated/filled curable silicone rubber composition (e-1) is cured under specific conditions to produce a fiber cloth layer. In this case, a single piece of the fiber cloth may be used or, alternatively, multiple pieces of the fiber cloths may be used in the form of a laminate, depending on the intended thickness. In the present invention, a fiber cloth layer having a desired thickness can be produced by appropriately varying the thickness of the fiber cloth and the number of the fiber cloths to be laminated. In the use of the fiber cloth layer thus produced, the mold-release-treated polymer film is removed.

The conditions for the curing of the curable silicone composition upon the impregnation of the fiber cloth are as follows. In the case of an addition-reaction-curable curable silicone composition, conventional curing conditions under which an addition-curable silicone composition can be generally cured may be employed, and the curing conditions are not particularly limited. The heating conditions may vary depending on the (Si—H/Si-alkenyl) molar ratio in the silicone composition, the type of the curing catalyst and the like, and preferably include a temperature of preferably 80 to 150° C., more preferably 100 to 130° C., and preferably about 1 minute to 1 hour, more preferably about 5 minutes to 30 minutes. In the case of an organic-peroxide-curable silicone composition, conventional curing conditions under which an organic-peroxide-curable silicone composition can be generally cured may be employed, and the curing conditions are not particularly limited. The heating conditions may vary depending on the type of the curing catalyst and the like, and include a temperature of preferably 80 to 150° C., more preferably 100 to 130° C., and preferably about 1 minute to 1 hour, more preferably about 5 minutes to 30 minutes. The conditions for molding the fiber cloth layer include a pressure of a pressing machine of about 0.1 to 35 MPa, more preferably about 0.5 to 5 MPa, for avoiding the formation of bubbles.

<Case where Thermosoftening Silicone Resin is Used>

Next, the method for producing a fiber cloth layer in which a fiber cloth is impregnated/filled with a thermosoftening silicone resin (e-2) is described.

A typical method for producing a fiber cloth layer in which a fiber cloth is impregnated/filled with a thermosoftening silicone resin (e-2) that is substantially solid under room temperature is as follows.

More specifically, a mold-release-treated polymer film is supplied (arranged) on a hot plate that is heated to a temperature at which a thermosoftening silicone resin (e-2), which is substantially solid under room temperature, can be melted (e.g., about 100° C.), then an untreated fiber cloth is supplied (arranged) on the polymer film, then a predetermined amount of the thermosoftening silicone resin (e-2) is supplied (arranged) on the fiber cloth and is thermally softened and liquefied in this state, and then the thermosoftening silicone resin is spread over the fiber cloth by bar coating to impregnate the fiber cloth with the thermosoftening silicone resin. Subsequently, another mold-release-treated polymer film is supplied (arranged) on the resultant product and is then thermally pressure-bonded. Subsequently, the mold-release-treated polymer films are removed to produce a fiber cloth layer having a desired thickness. In this case, a single of the fiber cloth may be used or, alternatively, multiple pieces of the fiber cloths may be used in the form of a laminate, depending on the intended thickness. In the present invention, a fiber cloth layer having a desired thickness can be produced by varying the thickness of the fiber cloth and the number of the fiber cloths to be laminated.

The conditions for the molding of the fiber cloth layer impregnated/filled with the thermosoftening silicone resin thus produced are not particularly limited. The heating conditions for a heating furnace preferably include a temperature of 50 to 200° C., more preferably 60 to 180° C., for avoiding the formation of bubbles. The pressure to be applied using a pressing machine is preferably about 0.01 to 35 MPa, more preferably about 0.05 to 5 MPa, for avoiding the formation of bubbles.

The fiber cloth layer in the heat-conductive composite silicone rubber sheet according to the present invention preferably has a layer thickness of 0.05 to 1.0 mm, more preferably 0.15 to 0.9 mm, still more preferably 0.2 to 0.8 mm, from the viewpoint of the prevention, reinforcement or the like of the deformation of a low-hardness heat-conductive silicone rubber layer.

The heat-conductive silicone rubber layer and the fiber cloth layer, which are produced by the above-mentioned methods, are laminated together to produce a heat-conductive composite silicone rubber sheet. A single piece of the fiber cloth layer may be used or, alternatively, multiple pieces of the fiber cloth layers may be used. The number of the layers may be one with which a fiber cloth layer having a desired thickness can be produced. Furthermore, for the purpose of reinforcing the strength of the laminate, the layers may be bonded to one another, as long as the heat conductivity cannot be deteriorated. With respect to the conditions for the lamination molding, the temperature is not particularly limited and is preferably room temperature, and the pressure of a pressing machine is preferably about 0.1 to 35 MPa, more preferably about 0.5 to 5 MPa, for avoiding the formation of bubbles.

### Production of Heat-Conductive Composite Silicone Rubber Molded Article Block

Multiple pieces of the heat-conductive composite silicone rubber sheets can be laminated together to produce a plate-like or columnar molded article block having a desired thickness. Alternatively, multiple pieces of the heat-conductive composite silicone rubber sheets can be laminated together and the resultant laminate can be wound around a winding core to produce a cylindrical molded article block having a desired thickness. With respect to the lamination, it is preferred to perform the lamination in such a manner that the directions of the highly heat-conductive fibers which serve as warps can become identical to each other. The volume ratio of the heat-conductive silicone rubber layer to the fiber cloth layer in the molded article block is preferably 20:80 to 95:5, more preferably 30:70 to 90:10. If the volume ratio of the heat-conductive silicone rubber layer is smaller than 20, the hardness of the surface may be increased, the stretchability characteristic of rubbers may be deteriorated, and voids may be formed as the result of a thermal history, resulting in the deterioration in heat conductivity. If the volume ratio is larger than 95, anisotropic heat conductivity may be deteriorated and therefore heat conductivity may be deteriorated. In the case where the sheet is wound around a winding core to form a molded article block, the winding core to be used is not particularly limited, and is preferably a tubular molded article formed from the same material as a material that forms the heat-conductive silicone rubber layer from the viewpoint of insusceptibility to the formation of voids and work efficiency. Furthermore, from the viewpoint of heat conductivity, it is preferred that the highly heat-conductive fibers that serve as warps become parallel with the winding core. The thickness of the molded article block (i.e., the thickness as observed in the orthogonal direction), on which the number of laminates or the frequency of winding can exert influence, is not particularly limited, and is preferably 5 to 50 mm from the viewpoint of the size of an integrated circuit element.

### Production of Anisotropic Heat-Conductive Composite Silicone Rubber Sheet

The anisotropic heat-conductive composite silicone rubber sheet according to the present invention can be produced by slicing the molded article block at an angle orthogonal to the length direction of the warps to produce a sheet. The processing method for producing the anisotropic heat-conductive composite silicone rubber sheet from the molded article block is not particularly limited, and various types of slicing processing methods may be employed. For example, the molded article block may be cut using a rotary blade or may be subjected to a laser processing to cut out the sheet therefrom. The thickness of the sheet that is cut out by slicing is preferably 0.1 to 20 mm, more preferably 0.2 to 10 mm. When the thickness of the sheet is 0.1 mm or more, it becomes possible to keep the shape of the sheet easily upon the slicing. When the thickness of the sheet is 20 mm or less, the excessive increase in thermal resistance can be avoided.

### Anisotropic Heat-Conductive Composite Silicone Rubber Sheet

The anisotropic heat-conductive composite silicone rubber sheet 5 thus produced has such a structure that the heat-conductive silicone rubber layers 1 each containing the heat-conductive filler and having Asker C hardness of 2 to 30 and the fiber cloth layers 2 each impregnated with the silicone rubber or silicone resin are arranged alternately, as shown in as shown in FIGS. 1B and 2B. In these cases, it is preferred that at least 5 pieces, preferably 10 to 100 pieces, more preferably 20 to 80 pieces, of the layers 1 and at least 5 pieces, preferably 10 to 100 pieces, more preferably 20 to 80 pieces, of the layers 2 are arranged alternately.

It is also preferred that the volume ratio of the heat-conductive silicone rubber layers 1 to the fiber cloth layers 2 is 20:80 to 95:5, particularly 30:20 to 90:10. Each of the heat-conductive silicone rubber layers 1 preferably has a width (P) of 0.01 to 10.0 mm, more preferably 0.02 to 5 mm, still more preferably 0.05 to 3 mm, and each of the fiber cloth layers 2 preferably has a width (Q) of 0.05 to 10 mm, more preferably 0.1 to 2 mm, still more preferably 0.1 to 1 mm. The ratio of the width (P) of each of the heat-conductive silicone rubber layers 1 to the width (Q) of each of the fiber cloth layers 2, i.e., (P):(Q), is preferably 20:80 to 95:5, more preferably 60:40 to 90:10. The thickness of the silicone rubber sheet is preferably 0.1 to 20 mm, more preferably 0.2 to 20 mm, still more preferably 0.2 to 10 mm.

### Examples

Hereinbelow, the present invention is described more specifically with reference to Examples and Comparative Examples. However, the present invention is not limited to the Examples mentioned below. In the following Examples, the viscosity is expressed by a value at 25° C.

### Examples, Comparative Examples

Firstly, the components of the heat-conductive silicone rubber layer to be used in the anisotropic heat-conductive composite silicone rubber sheet according to the present invention are as follows.

### <Heat-Conductive Silicone Rubber Layer>

### Component (a):

An organopolysiloxane represented by the following formula:

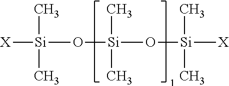

wherein X represents a vinyl group; and 1 represents a numeral providing any one of the following viscosities:

(A-1) kinematic viscosity: 600 mm²/s; and

(A-2) kinematic viscosity: 30,000 mm²/s.

### Component (b):

An organohydrogenpolysiloxane (B-1) represented by the following formula:

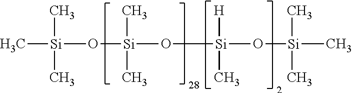

A 5-wt % chloroplatinic acid-toluene solution (B-2)

An organopolysiloxane (B-3) represented by the following formula:

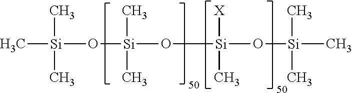

wherein X represents a vinyl group.

Benzoyl peroxide (B-4)

### Component (c):

An aluminum oxide powder having an average particle diameter of 5 μm (C-1)

An aluminum oxide powder having an average particle diameter of 1.5 μm (C-2)

### Production of Addition-Curable Heat-Conductive Silicone Rubber Layer

Dimethylpolysiloxane (A-1) which had a kinematic viscosity of 600 mm²/s at 25° C. and in which each terminal was capped with a dimethylvinylsiloxy group (65 parts by weight), dimethylpolysiloxane (A-2) which had a kinematic viscosity of 30,000 mm²/s at 25° C. and in which each terminal was capped with a dimethylvinylsiloxy group (35 parts by weight), an aluminum oxide powder (C-1) having an average particle diameter of 5 μm (300 parts by weight) and an aluminum oxide powder (C-2) having an average particle diameter of 1.5 μm (300 parts by weight) both of which served as heat-conductive fillers were kneaded using a planetary mixer at room temperature for 20 minutes, and the resultant mixture was filtrated through a 100-mesh strainer.

Subsequently, a 5-wt % chloroplatinic acid-toluene solution (B-2) (0.1 part by weight) was added to the filtrated product homogeneously, and then 1-ethynyl-1-cyclohexanol (0.1 part by weight) which served as an addition reaction regulator and KF-54 (3 parts by weight) which was a phenyl modified silicone oil manufactured by Shin-Etsu Chemical Co., Ltd. and served as an internal mold release agent for promoting the release from a separator were added the resultant mixture, and then the above-mentioned methylhydrogenpolysiloxane (B-1) (9.5 parts by weight) was further mixed with the mixture homogeneously at room temperature for 1 hour to produce a heat-conductive silicone rubber composition.

A heat-conductive silicone rubber composition used in Comparative Example 1 was prepared in the same manner as in the preparation of the above-mentioned heat-conductive silicone rubber composition, except that the dimethylpolysiloxane component in which each terminal was capped with a dimethylvinylsiloxy group was replaced by a polysiloxane component in which each terminal was capped with a dimethylvinylsiloxy group and which contained a phenyl group.

The heat-conductive silicone rubber composition was applied onto a polymer film that had been subjected to a mold release treatment. The heat-conductive silicone rubber composition was cured using a heating furnace that had been heated to 120° C. and a knife coater equipped with a winding device, and then the mold-release-treated polymer film was removed therefrom to produce a slightly surface-adhesive heat-conductive silicone rubber layer.

### Production of Organic-Peroxide-Curable Heat-Conductive Silicone Rubber Layer

A slightly surface-adhesive heat-conductive silicone rubber layer was produced in the same manner as in the production of the addition-curable heat-conductive silicone rubber layer, except that the 5-wt % chloroplatinic acid-toluene solution (B-2) (0.1 part by weight) was replaced by benzoyl peroxide (B-4) (0.5 part by weight) and the addition reaction regulator and methylhydrogenpolysiloxane were not added.

The components of the fiber cloth layers used in the anisotropic heat-conductive composite silicone rubber sheet were as follows.

### <Fiber Cloth Layer>

### Component (d):

A fiber cloth (plain weaving, 200 g/m², warps: 95% by weight) (D-1) in which graphitized carbon fibers (diameter: 10 μm, 500 W/mK) were used as warps and polyester fibers (diameter: 5 μm) were used as wefts.

Component (e-1):

The above-mentioned components (A-1), (A-2), (B-1), (B-2), (B-3) and (B-4).

Component (e-2):

A siloxane resin (E-2-1) represented by the following compositional formula:

D¹₂₅T₅₅D²₂₀

wherein D¹ represents a dimethylsiloxane unit (i.e., (CH₃)₂SiO_{2/2}); T represents a phenylsilsesquioxane unit (i.e., (C₆H₅)SiO_{3/2}); and D² represents a methylvinylsiloxane unit (i.e., (CH₃)(CH₂═CH)SiO_{2/2})
(number average molecular weight: about 2,000, softening point: 48° C.)

### Addition-Curable Silicone Rubber Composition to be Filled in Fiber Cloth

Dimethylpolysiloxane (A-1) which had a kinematic viscosity of 600 mm²/s at 25° C. and in which each terminal was capped with a dimethylvinylsiloxy group (65 parts by weight), dimethylpolysiloxane (A-2) which had a kinematic viscosity of 30,000 mm²/s at 25° C. and in which each terminal was capped with a dimethylvinylsiloxy group (35 parts by weight) and a 5-wt % chloroplatinic acid-toluene solution (B-2) (0.1 part by weight) were mixed homogeneously, and then 1-ethynyl-1-cyclohexanol (0.1 part by weight) which served as an addition reaction regulator and the above-mentioned methylhydrogenpolysiloxane (B-3) (5 parts by weight) were mixed with the resultant mixture homogeneously at room temperature for 1 hour to prepare a liquid curable silicone rubber composition to be filled in a fiber cloth.

Production of Fiber Cloth Layer Impregnated with Silicone Rubber (1)

A fiber cloth (D-1) was supplied (arranged) on a mold-release-treated polymer film, then the curable silicone composition was applied on the surface of the fiber cloth (D-1), then another mold-release-treated polymer film was arranged on the upper surface of the fiber cloth to form a fiber cloth sandwiched by two mold-release-treated polymer films. Subsequently, the fiber cloth sandwiched by the polymer films was subjected to a heat treatment using a heating press device under a pressure of 3 MPa at 120° C. for 10 minutes to fill the fiber cloth with the curable silicone composition and cure the filled fiber cloth, thereby producing a slightly surface-adhesive fiber cloth layer filled with a cured product of the silicone rubber.

### Organic-Peroxide-Curable Silicone Rubber Composition to be Filled in Fiber Cloth

A curable silicone rubber composition to be filled in a fiber cloth was produced in the same manner as in the production of the addition-curable silicone composition to be filled in a fiber cloth, except that the 5-wt % chloroplatinic acid-toluene solution (B-2) (0.1 part by weight) was replaced by benzoyl peroxide (B-4) (0.5 part by weight) and the addition reaction regulator and methylhydrogenpolysiloxane were not added.

Production of Fiber Cloth Layer Impregnated with Silicone Rubber (2)

A slightly surface-adhesive fiber cloth layer filled with a cured product of a silicone rubber was produced in the same manner as in the production of the fiber cloth layer impregnated with a silicone rubber using the addition-curable silicone rubber composition, except that the addition-curable silicone rubber composition to be filled in a fiber cloth was replaced by an organic-peroxide-curable silicone rubber composition to be filled in a fiber cloth.

Production of Fiber Cloth Layer Impregnated with Thermosoftening Silicone Resin

A mold-release-treated polymer film was supplied (arranged) on a hot plate at 100° C., then a fiber cloth (D-1) was supplied (arranged) on the polymer film, then the above-mentioned thermosoftening silicone resin (E-2-1) was supplied in a predetermined amount onto the fiber cloth (D-1) to liquefy the thermosoftening silicon resin, and then the thermosoftening silicone resin was spread over the fiber cloth by bar coating to impregnate the fiber cloth with the thermosoftening silicon resin. Subsequently, another mold-release-treated polymer film was arranged on the fiber cloth to form the fiber cloth sandwiched by the two mold-release-treated polymer films. Subsequently, the fiber cloth sandwiched by the two polymer films was subjected to a heat treatment using a heating press device under a pressure of 3 MPa at 120° C. for 10 minutes to fill the fiber cloth with the thermosoftening silicone resin. In this manner, a fiber cloth layer was produced.

### Production of Heat-Conductive Composite Silicone Rubber Molded Article Block

The mold-release-treated polymer film arranged on one surface of the slightly surface-adhesive heat-conductive silicone rubber layer (width: 35 mm, length: 100 mm) having each of the thicknesses shown in Tables 1 and 2 was removed, and then the slightly surface-adhesive fiber cloth layer (width: 35 mm, length: 100 mm) shown in the table in which the mold-release-treated polymer film on one surface thereof had been removed was arranged on the heat-conductive silicone rubber layer to produce a set of heat-conductive composite silicone rubber sheets. The heat-conductive composite silicone rubber sheets in the number shown in the table were prepared, then all of the mold-release-treated polymer films except the outermost mold-release-treated polymer films were removed, and then the resultant product was pressure-bonded at room temperature using a press machine under a pressure of 0.1 MPa in such a manner that the directions of the carbon fibers became identical to each other to produce a heat-conductive composite silicone rubber molded article block having a size of 35 mm wide×100 mm long×35 mm thick.

### Production of Anisotropic Heat-Conductive Composite Silicone Rubber Sheet

The heat-conductive composite silicone rubber molded article block was cut vertically relative to the length direction of the carbon fibers using a round-blade slicer A70 (a rotary blade; manufactured by Hakura Seiki Co., Ltd.) at a thickness of 2 mm to produce an anisotropic heat-conductive sheet having a size of 35 mm wide×35 mm long×2 mm thick.

### Evaluation Procedures

The anisotropic heat-conductive composite silicone rubber sheets thus produced were tested/measured and evaluated with respect to the following properties. The results are shown in Tables 1 and 2.

### [Hardness of Heat-Conductive Silicone Rubber Layer]

Multiple pieces of the heat-conductive silicone rubber layers were stacked to form a laminate having a thickness of 10 mm, and the hardness of the laminate was measured using an Asker C hardness meter.

### [Compression Rate of Anisotropic Heat-Conductive Composite Silicone Rubber Sheet]

A load of 0.3 MPa was applied onto the anisotropic heat-conductive composite silicone rubber sheet, and a compression rate, which correlated with a surface hardness, was measured.

### [Adhesiveness of Anisotropic Heat-Conductive Composite Silicone Rubber Sheet]

A load of 0.3 MPa was applied onto the anisotropic heat-conductive composite silicone rubber sheet, then the sheet was bonded to an aluminum plate having a size of 50 mm wide×50 mm long×1 mm thick, and then the aluminum plate was fixed vertically. The adhesiveness of the anisotropic heat-conductive composite silicone rubber sheet was evaluated based on the presence or absence of detachment of the sheet after 1 hour.

Rating A: detachment was not observed.

Rating B: detachment was observed.

### [Measurement of Thermal Resistance]

The heat resistance of the anisotropic heat-conductive composite silicone rubber sheet was measured in accordance with ASTM-D5470 under a load of 0.3 MPa.

TABLE 1

| | | Example | | | | | |
|---|---|---|---|---|---|---|---|
| | | 1 | 2 | 3 | 4 | 5 | 6 |
| Heat- | Type | Addition- | Addition- | Addition- | Addition- | Organic | Addition- |
| conductive | | curable | curable | curable | curable | peroxide- | curable |
| rubber layer | | | | | | curable | |
| | Asker C hardness | 7 | 7 | 7 | 7 | 7 | 7 |
| | Heat conductivity | 3 | 3 | 0.5 | 3 | 3 | 3 |
| | (W/mK) | | | | | | |
| | Thickness (mm) | 0.5 | 0.5 | 0.3 | 0.5 | 0.5 | 0.5 |
| Fiber cloth | Type of | Addition- | Organic | Addition- | Thermo- | Thermo- | Thenno- |
| layer | impregnated | curable | peroxide- | curable | softening | softening | softening |
| | silicone | | curable | | | | |
| | Thickness (mm) | 0.25 | 0.25 | 0.25 | 0.25 | 0.25 | 0.25 |

| | | | | | | |
|---|---|---|---|---|---|---|
| Number of heat-conductive composite | 50 | 50 | 50 | 50 | 50 | 50 |
| silicone rubber sheets laminated | | | | | | |
| Ratio of thickness of heat-conductive | 71/29 | 71/29 | 65/35 | 71/29 | 71/29 | 71/29 |
| silicone rubber layer to thickness of | | | | | | |
| fiber cloth layer | | | | | | |
| Compression rate (%) | 64 | 64 | 74 | 61 | 55 | 53 |
| Adhesiveness | A | A | A | A | A | A |
| Heat resistance (K-mm²/W) | 35 | 134 | 27 | 107 | 115 | 315 |

TABLE 2

| | | Comparative Example | |
|---|---|---|---|
| | | 1 | 2 |
| Heat-conductive | Type | Addition-curable | Addition-curable |
| rubber layer | Asker C hardness | 50 | 7 |
| | Heat conductivity (W/mK) | 3 | 3 |
| | Thickness (mm) | 0.5 | 0.5 |
| Fiber cloth layer | Type of impregnated silicone | Thermosoftening | — |
| | Thickness (mm) | 0.25 | |

| | | |
|---|---|---|
| Number of heat-conductive composite silicone rubber | 50 | 50 |
| sheets laminated | | |
| Ratio of thickness of heat-conductive silicone rubber | 71/29 | 100/0 |
| layer to thickness of fiber cloth layer | | |
| Compression rate (%) | 76 | 73 |
| Adhesiveness | B | A |
| Heat resistance (K-mm²/W) | 540 | 1,015 |

As apparent from Table 1, all of the anisotropic heat-conductive composite silicone rubber sheets produced in Examples were excellent with respect to compression properties, adhesiveness and heat dissipation properties.

As apparent from Table 2, if the hardness of a heat-conductive silicone rubber layer was large as in the case of Comparative Example 1, adhesiveness was deteriorated and consequently heat dissipation properties were significantly deteriorated. If a molded block was composed of only a heat-conductive silicone rubber layer and had no fiber cloth layer as in the case of Comparative Example 2, heat dissipation properties were significantly deteriorated.

Japanese Patent Application No. 2018-006139 is incorporated herein by reference.

Although some preferred embodiments have been described, many modifications and variations may be made thereto in light of the above teachings. It is therefore to be understood that the invention may be practiced otherwise than as specifically described without departing from the scope of the appended claims.

1. A method for producing an anisotropic heat-conductive composite silicone rubber sheet, comprising:
bonding a heat-conductive silicone rubber layer to a fiber cloth layer to produce each of heat-conductive composite silicone rubber sheets, wherein the heat-conductive silicone rubber layer contains a heat-conductive filler and has an Asker C hardness of 2 to 30, and the fiber cloth layer is produced by impregnating a fiber cloth in which warps comprise highly heat-conductive fibers each having a heat conductivity of 100 W/mK or more with a silicone rubber or a silicone resin;
laminating the heat-conductive composite silicone rubber sheets on each other or winding the heat-conductive composite silicone rubber sheets around a winding core to form a molded article block; and
slicing the molded article block at an angle orthogonal to length direction of the warps to produce a sheet.

2. The method for producing an anisotropic heat-conductive composite silicone rubber sheet according to claim 1, wherein each of the heat-conductive silicone rubber layers is a silicone rubber layer produced by curing a silicone rubber composition comprising (a) a curable organopolysiloxane, (b) a curing agent and (c) a heat-conductive filler.

3. The method for producing an anisotropic heat-conductive composite silicone rubber sheet according to claim 1, wherein the silicone rubber with which the fiber cloth layers are impregnated is a curable silicone rubber composition comprising (a) a curable organopolysiloxane and (b) a curing agent, and each of the fiber cloth layers is formed by impregnating a fiber cloth in which warps comprise highly heat-conductive fibers each having a heat conductivity of 100 W/mK or more with the curable silicone composition and then curing the impregnated product.

4. The method for producing an anisotropic heat-conductive composite silicone rubber sheet according to claim 1, wherein the silicone resin with which the fiber cloth layers are impregnated is a thermosoftening silicone resin that is substantially solid under room temperature, and each of the fiber cloth layers is formed by impregnating/filling a fiber cloth with the thermosoftening silicone resin.

5. The method for producing an anisotropic heat-conductive composite silicone rubber sheet according to claim 1, wherein each of the heat-conductive silicone rubber layers has a heat conductivity of 0.5 W/mK or more.

6. The method for producing an anisotropic heat-conductive composite silicone rubber sheet according to claim 1, wherein the volume ratio of the heat-conductive silicone rubber layers to the fiber cloth layers in each of which warps comprise highly heat-conductive fibers each having a heat conductivity of 100 W/mK or more is 20:80 to 95:5.

7. The method for producing an anisotropic heat-conductive composite silicone rubber sheet according to claim 1, wherein, in each of the fiber cloth layers, the weight ratio of the warps is 90% by weight or more.
